(19) United States
(12) Patent Application Publication
(10) Pub. No.: US 2017/0129375 A1
(43) Pub. Date: May 11, 2017

(54) VENTILATION DEVICE FOR SUPPLYING AIR TO A PASSENGER ON A VEHICLE SEAT

(71) Applicant: GENTHERM AUTOMOTIVE SYSTEMS (CHINA) LTD., Langfang, Hebei (CN)

(72) Inventor: Jonathan Zhang, Tianjin (CN)

(21) Appl. No.: 15/317,486

(22) PCT Filed: Jun. 12, 2014
(86) PCT No.: PCT/CN2014/079751

§ 371 Date: Dec. 9, 2016

(51) Int. Cl. B60N 2/56

(52) U.S. Cl. CPC B60N 2/5621; B60N 2/565; B60N 2/5657; B60N 2/5692; B60N 2/5635

(57) ABSTRACT

A ventilation device (6) for supplying air to calves of a passenger on a vehicle seat is provided. The ventilation device (6) has: an air moving device (7) for moving air, and an air guiding device (8) for guiding air from at least one intake opening (24) towards the air moving device (7) or from the air moving device (7) towards at least one discharge opening (50). A calf warmer (2) having said ventilation device (6), a calf cooler (20) having said ventilation device (6), and a body support (1) for passengers of a vehicle which being provided with said ventilation device (6), said calf warmer (2) and said calf cooler (20) are provided.

### TECHNICAL FIELD

The present invention refers to a ventilation device according to claim 1. It is used to increase the individual thermal comfort of passengers of a vehicle.

### BACKGROUND OF THE INVENTION

There are seats, which ventilate the back, buttocks and legs of a passenger.

### SUMMARY OF THE INVENTION

The present prior art can be further improved in view of individual thermal comfort and efficiency.

### BRIEF DESCRIPTION OF THE DRAWINGS

Details of the invention will be discussed in the following. This description shall explain the invention. However, it is provided only as an example. In the area of the invention defined by the claims, one or more of the described features may be omitted, changed, or supplemented. The features of various embodiments may be combined with one another. If a requirement shall be fulfilled at least partially, this means that this feature can also be completely fulfilled or essentially completely fulfilled. “Essentially” means the implementation achieves the desired result to a recognizable extent, for example, a respective condition may be fulfill at least 50%, 90%, 95%, or 99%. If a minimum amount is given, then of course an amount larger than this minimum may be used. When something is described in view or one object, then this can be used for the predominant share or the totality of all other similar objects. Unless noted otherwise, the intervals include their boundary points.

In the following, reference is made to:

FIG. 1 Vehicle in a partial longitudinal section

FIG. 2 Perspective view of a seat with a calf warmer

FIG. 3 Perspective view of the calf warmer of FIG. 2

FIG. 4 Channel segment of an air guiding device of a calf warmer of FIG. 2 in perspective view

FIG. 4 a) First alternative configuration of intake and discharge openings

FIG. 4 b) Second alternative configuration of FIG. 4 a)

FIG. 4 c) Third alternative configuration of FIG. 4 a)

FIG. 5 Cross section of an air guiding device with heater of a calf warmer of FIG. 2

### DETAILED DESCRIPTION OF PREFERRED EMBODIMENTS

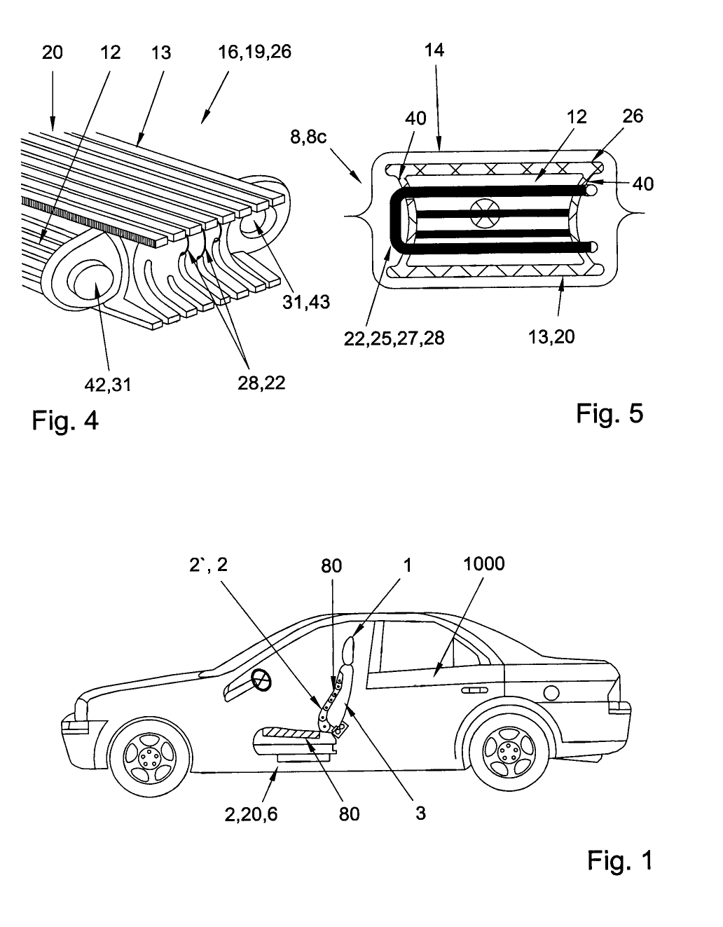

FIG. 1 shows a vehicle 1000. This can be, e.g. an airplane, a railway vehicle, a ship, or a motor vehicle as in the present case.

The vehicle 1000 has at least one body support 1, what means any device that supports a passenger, especially seats or benches.

Such a body support 1 can be provided with a surface conditioning device 80. “Conditioned surfaces” are the user-supporting surfaces of the body support, namely the A-side of the seat cushion and the backrest. “Surface conditioning” shall mean climate control of conditioned surfaces. Climate control can be ventilation, heating and/or cooling of conditioned surfaces. So a surface conditioning device e.g. can be or have a flat surface heating element or spacer fabrics below a seat cover.

Many people do not like their face or trunk directly being charged with wind or heat. But in the area of the lower legs this is accepted. Further, often passengers tend to get cold feet due to insufficient blood circulation during longer drives. So the vehicle 1000 and/or at least one body support 1 is equipped with at least one ventilating device 6 for supplying air to calves of a passenger on a vehicle seat. “Ventilating device” here means in particular a device that can be used for a change of air or air flows in a foot/calf area of a vehicle's seat.

The ventilating device 6 preferably is capable of being operated independently from the surface conditioning device 80. Independent operation can be achieved by providing the ventilating device 6 as a separate system with independently assembled components. In case of jointly used components, an independent operation can be achieved by independent control of the calf ventilation function. In this way, a calf heating or cooling independent of the ventilation device 80 for climate control of a seat surface increases the thermal comfort of a passenger.

The ventilating device 6 can be a part of a calf warmer 2, which allow sheating of at least one calf area of a passenger. To heat air, the calf warmer 2 is provided with a temperature control device 22, e.g. a PTC heater, a Peltier device or an electrical resistor.

Further, the ventilating device 6 can be a calf cooler 20 or a part of it, which allows cooling of at least one calf area of a passenger. To improve its cooling performance, it can be provided with an additional or alternative control device 22, e.g. a Peltier device or a compressor.

The ventilating device 6 has one or more air moving devices 7 for moving air by pulling air from the foot/calf area or from behind and/or underneath a body support 1 and for ejecting it toward a user's calves. A radial fan is especially suitable here, but an axial ventilator could be used either.

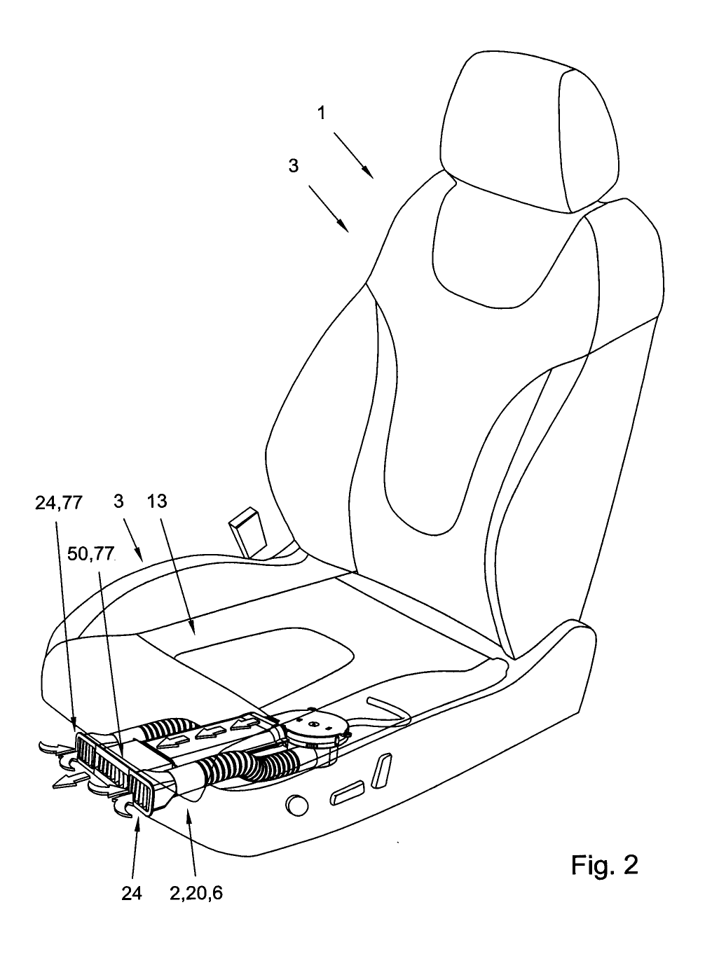

The air moving device 7, as shown in FIG. 2, can be arranged beneath a seat or seat cushion, especially within a cushion 3 or under the B-side (facing away from the user)of the cushion 3 or its support structure, in order to achieve a good vibration attenuation.

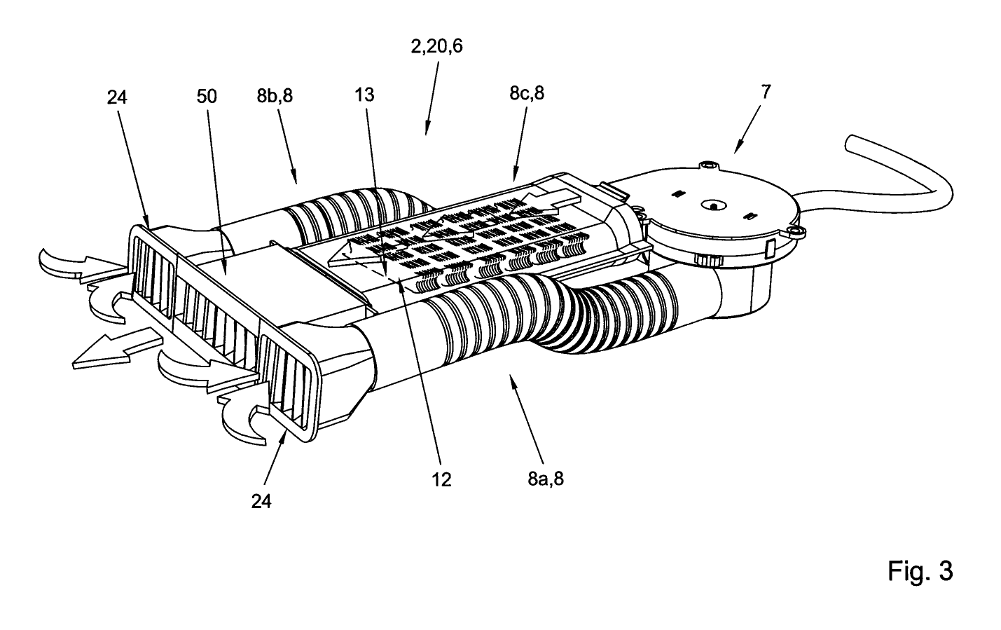

The ventilation device 6 and/or the body support 1 are provided with at least one discharge opening 50. This discharge opening 50 is in an area, which is associated with a calf of a passenger. Via this discharge opening 50 air is discharged from the ventilation device 6 towards a least one leg or calf of a passenger. In FIG. 3 the discharge opening 50 is arranged in a center area relative to a length axis of the passenger's body.

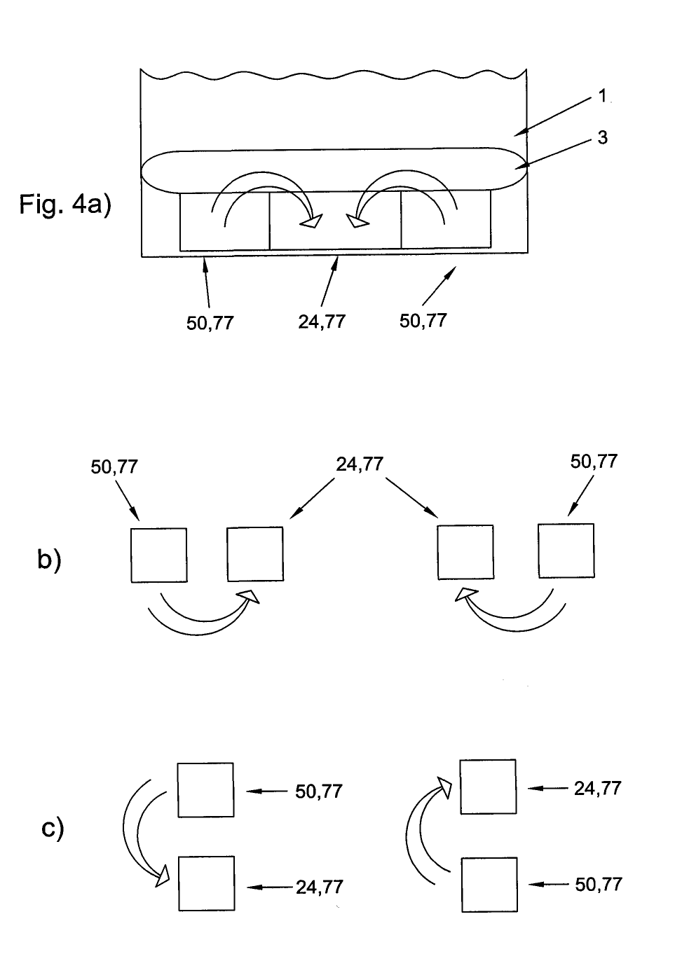

The ventilation device 6 and/or the body support 1 are provided with at least one intake opening 24. This intake opening 24 is in an area, which is associated with a calf of a passenger, too. Via this intake opening 24, air is pulled into the ventilation device 6 towards the air moving device. In FIG. 3 there are two intake openings 24, which are arranged on the left and right and on the same level relative to the discharge opening 50 and a lengthwise direction of the vehicle. This provides the user with heated air quickly. But number and arrangement of the openings can just be reversed as in FIG. 4 a) to allow a better heating even of colder areas near the walls of the vehicle body.

Preferably the ventilating device 6 has one or more air guiding devices 8 to transport air from one or more air intake openings 24 via one or more intake channels 8a, 8b towards the air moving device 7. Further, the air guiding device 8 can be used to guide air from the air moving device 7 via one or more discharge channels 8c towards one or more air discharge openings 50. In FIG. 3 there are two intake openings 24, which are arranged on the left and right and on the same level relative to the discharge opening 50 and a lengthwise direction of the vehicle.

Preferably there are one or more discharge openings 50 for each leg, preferably separated from each other. Alternatively or additionally there are one or more intake openings 24 for each leg, preferably separated from each other.

At least one intake opening 24 and/or at least one discharge opening 50 represents at least one interface surface 77. This interface surface 77 is an interface between a ventilated calf area and the ventilation device 6. Preferably a ventilation device 6 is provided with at least two interface surfaces 77, at least one of them being an intake opening 24 and/or at least one other being a discharge opening 50. This allows the air to circulate between the foot/calf area and the ventilating device 6. This improves heating of cooling, as the system is provided with already temperature preconditioned air.

At least one interface surface 77 can be covered by a grille and or be supplied with one or more jets. Preferably at least one interface surface 77 is positioned apart from the level of the closest user-contacted seat surface, especially below and/or behind that level. This avoids tactile discomfort coursed by unintended contact with hard parts like jets or grilles.

At least one intake opening 24 can be arranged directly beside at least one discharge opening 50 as in FIG. 3 to simplify the structure. But they can also be separated from each other as in FIG. 4 b) and c) to improve the flow of air through the foot/calf area.

It can be advantageous, if both of the two interface surfaces 77 are arranged on the same height level relative towards ground like in FIG. 3, 4 a) and b). This will result in a stream of air, which crosses the leg of the passenger. Thus its effect tends be direct and punctual.

It can be advantageous, if each of the two interface surfaces 77 is arranged on a height level respective towards ground that differs from the height level of the other interface surface 77, like in FIG. 4 c). This will result in a stream of air, which passes along the leg of the passenger. Thus its effect tends to influence a larger area. It can be advantageous if the upper interface surface 77 is a discharge opening 50, especially for a calf cooler. For some applications it can be preferred it the upper is an intake opening 24, especially for a calf cooler. If the lower interface surface 77 is respectively the other type of opening 24, 50 this corresponds to the tendency of the discharged air to sink down if it is cooled and rise if warmed.

In case the body support 1 is a driver seat, it can be advantageous to arrange at least one interface surface 77 in an asymmetric way. To describe this in detail, a reference plain shall be defined for the body support 1 by the middle plain, which separates the right and the left side of the driver. If at least one interface surface 77 is arranged at a position apart from the middle plain, then at least in view of a position corresponding to this interface surface 77 on the respective other side of the plain, the ventilation device is asymmetric. This means, at that position there is no corresponding interface surface 77. Or there is a second interface surface, but its function differs from the first one. E.g while the first interface surface 77 is an air intake opening 24, the second interface surface 77 is an air discharge opening 50, thus referring the direction of the flow of air. Preferably the driver's leg, which is operates the gas pedal, is closer to the seat and moving more often than the other leg. Therefore it is preferred to use a different position, jet or discharge angle here for at least one interface surface 77 than for the other, more distant leg.

Preferably an air guidance device 8 has at least one separating device 13. “Separating device” means in particular a device that can restrict or prevent the compression of an air guiding free space 12 of the air guidance device.

Preferentially an air guidance device 8 has at least one enclosure device 14. The term “enclosure device” refers in particular to a device that prevents the air guided within the air guiding device from leaking at an undesired location.

It is recommended that an enclosure device 14 is at least partially made of a material that inhibits a flow of air. Especially suited are foils that are not air permeable, a plastic foil, a foam plate essentially not permeable for air, and stiff plastic profiles.

It is advantageous if at least one enclosure device 14 at least partially surrounds a separating device 13, so that it results in an at least locally closed enclosure which is running essentially along the direction of the air guiding device 8.

Preferentially an air guidance device 8 has at least one channel segment 19. “Channel segment” means in particular a component that allows its relative movement in relation to the other components, which are in the air flow before or behind that channel segment. In particular it means that they are movable, capable, swivelable, and/or bendable along the length and/or along the width. A component is preferentially stiff or less elastic.

To provide a longitudinal air flow channel, two or more channel segments 19 are positioned next to one another and set up behind one another in the direction of the current. It can be useful to provide such channel segments 19 in a plurality of 2 to 50 pieces.

It is advisable that a channel segment 19 has at least one segment frame 20. “Segment frame” refers in particular to a component that has two sides of a hollow space cross-section supporting each other (cross-section relative to the direction of the air stream). A cross-section of a round or right angle pipe section is especially suitable.

A material that is stable under pressure and stiff is recommended for this. For example, plastics come under consideration, in particular polymers that are strengthened by fibers.

It is advantageous that a channel segment 19 have at least one segment joint 31. The term “segment joint” means in particular a device that allows pivoting of a channel segment 19 relative to a channel section positioning either in front of or behind the channel segment 19. This allows the realization of channels that are stable under pressure and more bendable, or more arched. An example are projections 42 or recesses 43, which are provided as turning points on the channel segment 19 at their central axis, and take hold of corresponding projections or recesses of another component.

Advantageously, a calf warmer 2, a calf cooler 20 or a ventilation device 6 have at least one temperature control device 22. “Temperature control device” means in particular a device that can be used for a change of temperature in its environment. Especially suitable for such are heating devices, cooling devices, a Peltier element, a heat conducting pipe, and/or an air moving device, such as a ventilator. It can be especially favorable if the temperature control device 22 is set up for direct current and/or low voltage, especially for 12 V or 24 V.

Preferentially, a temperature control device has at least one conductor bundle. The word “conductor bundle” means in particular an electrical conducting bundle of lines. “Bundle” means in particular an object whose extent in one direction is much greater than in the other 2 dimensions (e.g., 10 times greater). Preferentially the bundle is elastic in bending, strong, and has similar dimensions in both cross-section dimensions. It can be a monofilament or a multifilament.

It is advisable that a temperature control device 22 have at least one heating device 25. The term “heating device” refers in particular to a device for warming its environment by providing thermal energy and radiating heat by means of conduction, convection, and/or through heat radiation. Examples are an electric heat resistor, a flexible textile flat heating element, a heat pump, a Peltier element, a radiator, a conductor, a PTC element and/or a heating spiral.

It is good that a heating device 25 has at least one heat resistor carrier 26. “Heat resistor carrier” means in particular a device for mechanical carrying of a heat resistor and/or for fixing its spatial location. Especially suitable are flexible flat objects, preferentially at least partially made of a textile, fabric, mesh, woven material, fleece, bendable thermoplasts, stamped or dimpled foil, air permeable material, a conditioned area itself, a portion of its surface or stiffened components, profiles, hollow bodies, or segment frames 20 of an air guidance channel.

Preferably a heating device 25 has at least one temperature control bundle 28. The word “temperature control bundle” includes in particular a strand-like component for providing or removing heat along the bundle, e.g., a heat resistor 27 or a heat conducting pipe.

Advantageously a temperature control bundle 28 has at least partially a position that results in efficient temperature control of the air that streams past. As an example, windings around an air conduction channel or lines across the direction of the flow of air within an air channel. It is particularly favorable to guide the temperature control bundle into or around individual channel segments, in particular to have them laid into recesses of the channel. A preferred embodiment results if a temperature bundle 28 winds around a channel segments and is laid into recesses in the segment frames. In this way the parts of the temperature control bundle that change the temperature of the air flow are in contact with by the fluid. It can be advisable for several sections of the temperature control bundle to be laid down on different levels within the air channel in order to evenly heat the airstream. “Level” refers to the height of the cross-section of the air channel.

1. A ventilation device comprising:
an air moving device for moving air,
an air guiding device for guiding air from at least one intake opening towards the air moving device or from the air moving device towards at least one discharge opening 50; and
wherein the ventilation device supplies air to calves of a passenger on a vehicle seat.

2. The ventilation device according to claim 1, having at least two interface surfaces, each of the two interface surfaces forming an interface between a ventilated calf area and the ventilation device, at least one of interface surfaces being an intake opening and at least one other being a discharge opening.

3. The ventilation device according to claim 1, wherein the ventilation device is operated independently from a surface conditioning device for a climate control of a conditioned surface of the seat.

4. A calf warmer comprising:
at least one ventilation device according to claim 1, and
a further temperature control device.

5. A calf cooler comprising:
at least one ventilation device according to claim 1; and
optionally a further temperature control device.

6. A body support for passengers of a vehicles, the body support being provided with:
a ventilation device according to claim 1.

7. A body support according to claim 6, wherein the body support has a surface conditioning device for conditioning at least one user-contacted surface of the body support and being capable of operating the surface conditioning device and the ventilation device independent from each other.

8. A body support according to claim 6, wherein the body support includes at least two interface surfaces, the at least two interface surfaces forming an interface between a ventilated calf area and the ventilation device, but each of them being arranged on a height level respective towards ground that differs from the height level of the other interface surface,
wherein at least one interface surface being a discharge opening and
at least one other interface surface being an intake opening.

9. A body support according to claim 6, wherein the body support has at least two interface surfaces, the at least two interface surfaces each forming an interface between a ventilated calf area and the ventilation device, the at least two interface surfaces being arranged on a same height level relative towards ground,
wherein at least one interface surface a discharge opening and
at least one other interface surface being an intake opening.

10. A body support according to claim 8, wherein
the body support is a driver seat,
the body support has a middle plain, which separates the right and the left side of the driver,
at least one interface surface is arranged at a position apart from the middle plain, and
at least in view of a position corresponding to this interface surface on the respective other side of the plain, the ventilation device is asymmetric.

11. The ventilation device according to claim 2, wherein the ventilation device is operated independently from a surface conditioning device for a climate control of a conditioned surface of the seat.

12. A calf warmer comprising:
at least one ventilation device according to claim 2, and
a further temperature control device.

13. A calf warmer comprising:
at least one ventilation device according to claim 11, and
a further temperature control device.

14. A calf cooler comprising:
at least one ventilation device according to claim 3; and
optionally a further temperature control device.

15. A calf cooler comprising:
at least one ventilation device according to claim 11; and
optionally a further temperature control device.
